(19) United States
(12) Patent Application Publication
(10) Pub. No.: US 2020/0149669 A1
(43) Pub. Date: May 14, 2020

(54) FLIP CAP WITH HOSE BARB

(71) Applicants: Brandon Ragan, Srpingfield, VA (US); Philip Ragan, SR., 477 Towney Hill Rd., NY (US)

(72) Inventors: Brandon Ragan, Srpingfield, VA (US); Philip Ragan, SR., 477 Towney Hill Rd., NY (US)

(21) Appl. No.: 16/189,998

(22) Filed: Nov. 13, 2018

(51) Int. Cl. F16L 37/05; F16L 37/08

(52) U.S. Cl. CPC F16L 37/05; F16L 2201/10; F16L 37/08

(57) ABSTRACT

A dispensing cap for a container such as a bottle or pouch. The nozzle of the cap is designed to connect a hose and the nozzle is connected to the cap base in a manner that allows the nozzle to operate like a valve. While the nozzle is in the closed position an air or liquid tight seal is made between the nozzle and cap base. While the nozzle is in the upright and open position the passage of air or liquid is allowed through the cap for the purpose of dispensing a liquid from within a container.

### BACKGROUND OF THE INVENTION

### Field of the Invention

The present invention relates to plastic caps used for dispensing a substance from a container such as a bottle or pouch, where the cap comprises a flip up nozzle with a hose barb for connecting a hose to the nozzle.

The invention was required to solve several problems with prior art caps used on a bottle or pouch for applying tire sealant into a tire through a valve stem. The position of the valve stem on the tire is random and this required a cap with an easy open and close mechanism to attach the cap to the valve stem without spillage or waste regardless of the pouch or bottle orientation. For example, the bottle or pouch is required to be tilted upside down to install tire sealant through the valve stem of a tire. To avoid spillage while the bottle or pouch is tiled upside down it is desirable for the cap to have a valve mechanism to start and stop the flow of tire sealant while the cap is attached to the valve stem of the tire. Once the cap is attached to the valve stem it must be easy to open to avoid pulling the attached cap off from the valve stem during application. Furthermore, while the pouch or bottle is in storage or transport it is required that the cap seal air or liquid tight and it is desirable to have a single cap that can be used to store, transport and dispense the product.

### SUMMARY OF THE INVENTION

It is an object of the present invention to create a cap that has a nozzle with a hose barb for the purpose of connecting a hose to the cap.

It is another object of the present invention to have a nozzle that can open and close to operate like a valve by pivoting the nozzle on a hinge created between the cap base and nozzle connection.

It is another object of the present invention to create an air or liquid tight seal between the nozzle and the cap base while the nozzle is in the closed position.

It is another object of the present invention to create a passageway for dispensing a substance through the cap base and nozzle while the nozzle is in the upright and open position.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is a top plan view of a cap according to the present invention.

FIG. 2 is a cross-sectional view of the nozzle of the cap.

FIG. 3 is a break out view of the nozzle.

FIG. 4 is a perspective view of the cap in the open position.

FIG. 5 is a cross-sectional view of the cap in a closed position.

FIG. 6 is a perspective view of the cap in a closed position.

FIG. 7 is a cross-sectional view of the cap in an open position.

Similar reference characters denote corresponding features consistently throughout the attached drawings.

### DETAILED DESCRIPTION OF THE PREFERRED EMBODIMENT(S)

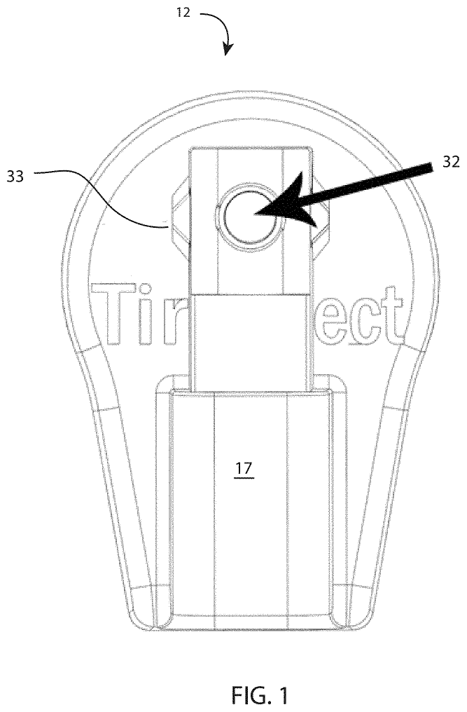

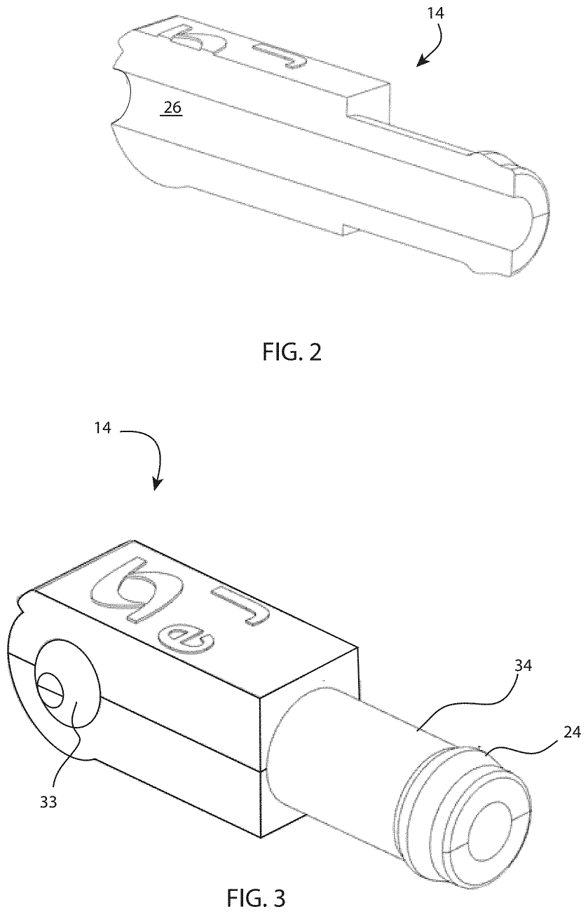

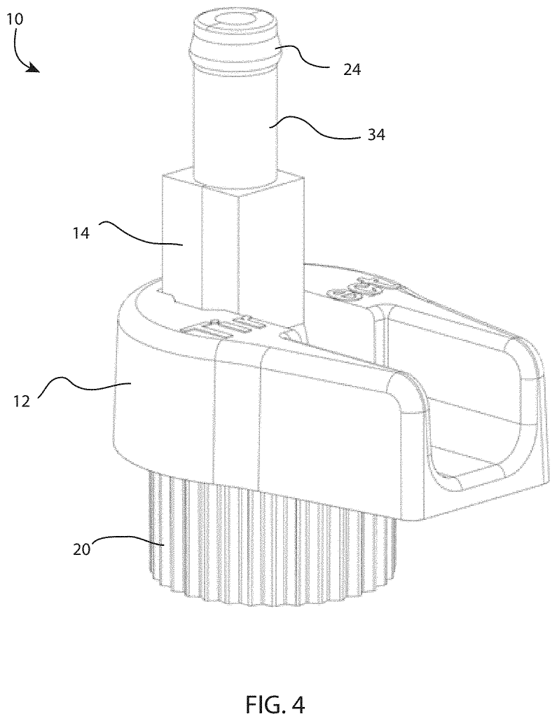

FIG. 1 shows the preferred embodiment of the present invention, which includes a two-piece cap design 10 comprised of the cap base 12 and the cap nozzle 14. The cap nozzle 14 includes two key features, namely a stem 34 and a barb 24. FIG. 3 details the cylindrical stem 34 with a hose barb notch 24 for receiving and securely affixing a hose (not shown) onto the end of the nozzle stem 34. The barb is flared so that the hose fits on by an interference fit to seal the hose to the stem. Connection points 33 that jut out from each side of the nozzle used to form a hinge when connected with the cap base 12 (FIG. 1). The aforementioned hinge 33 allows the nozzle 14 to pivot from the closed position (FIG. 6) to the upright and open position as seen in FIG. 4, as will be explained further hereunder.

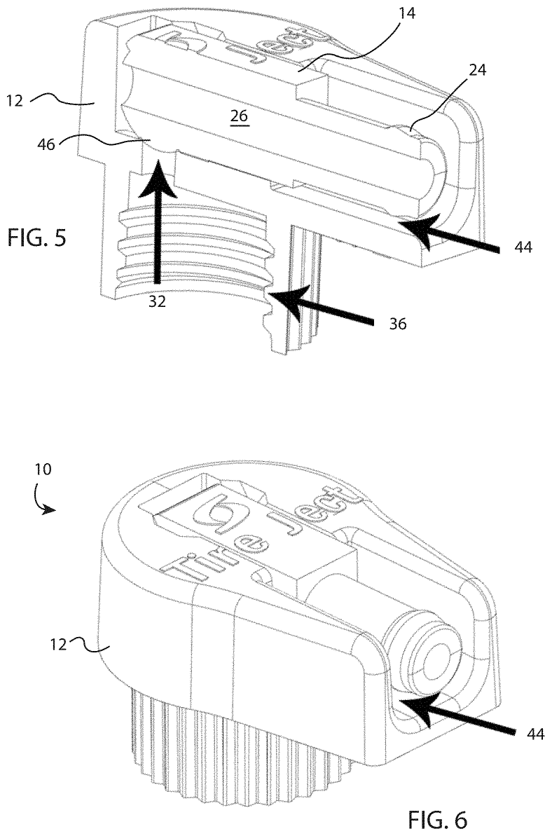

The cap base 12 of FIG. 1 includes a widened channel 17 and is further detailed in FIG. 5. The widened channel 17 leaves clearance around the cap nozzle for a hose affixed to the stem of the nozzle 34. Referring to FIG. 1, the cylinder stem 34 is designed with a reduction in the nozzle diameter relative to the channel 17 so that the combined hose and stem will fit within the cap channel 17 when the nozzle is in the closed position. FIG. 5 shows the cross section of the cap base and nozzle while in the closed position having a clearance 44 created between the cap channel 17 and the cylindrical nozzle stem 34 that allows the nozzle to fully close while a hose is affixed to the nozzle stem 34. These aforementioned features are novel aspects of the cap design to affix a hose for the purpose of dispensing a tire sealant liquid from a container into a tire through a valve stem. The benefit of this cap design is to provide a cap for a container that does not require assembly and the cap can be used with a container for storage, transportation and installation of a liquid with the valve like operation of the nozzle with a hose affixed and ready to use.

FIG. 5 also details the cap base 12 and nozzle 14 connected together by the aforementioned connection points at 33 into the cap base with the nozzle in the closed position. FIG. 5 details the ridge (“radius”) 46 on the underside of the nozzle 14 that makes a seal to the opening 32 of the cap base 12. The seal between the opening in the cap base 32 and the nozzle ridge 46 is made while the nozzle is in the closed position and creates an air tight seal between the radius and the walls of the chamber 32 that allows for a substance to be contained within a bottle or pouch while the cap is affixed until chamber 32 aligns with the passage 26 of the nozzle 14.

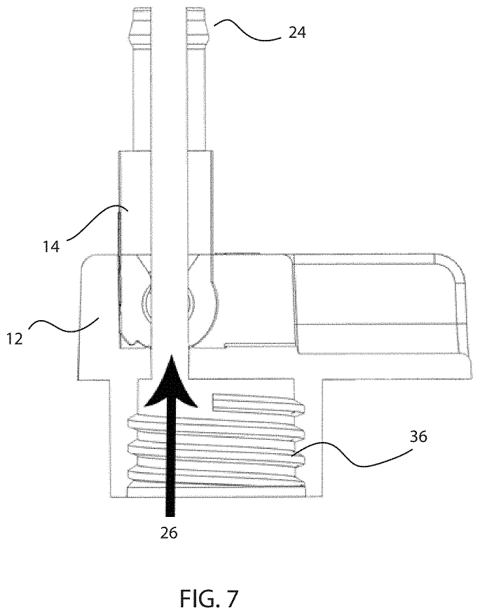

FIG. 7 shows a cross section of the cap base 12 and nozzle 14 with the nozzle in the upright and open position. The nozzle 14 is connected to the cap base 12 by the connection points 33 which snaps into place and rotatingly connects into the cap base. The connection points allow the nozzle to hinge and pivot from the closed position to the open position. While the nozzle is in the upright and open position (FIG. 7) the opening in the cap base 32 aligns with the opening and passage way 26 within the nozzle 14. The opening or passageway 26,32 created through both the cap base 12 and nozzle 14 while the nozzle is positioned in the upright and open position allows for the passage and dispensing of a liquid within a container to the exterior.

The preferred embodiment of the cap is shown connecting to a container by threads 36, but the present invention is not limited to this embodiment and the cap could be connected to the container by any method.

While this invention has been described as having a preferred design, it is understood that it is capable of further modifications, uses and/or adaptations of the invention following in general the principle of the invention and including such departures from the present disclosure as come within the known or customary practice in the art to which the invention pertains and applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

We claim:

1. A cap device connecting to a bottle or pouch for containing and dispensing a substance, the device comprising of:
a. A cap with separate base and nozzle pieces.
b. Nozzle with a hose barb.
c. Nozzle attaches to the base piece and pivots on a hinge from one end of the nozzle to move into the open and upright position or closed position.
d. Operates as a valve to move from the closed position and into the open position to allow passage of a substance.

2. Nozzle of cap device in accordance with claim 1 that contains a tubular passage way for dispensing a substance.

3. Cap base and Nozzle in accordance with claim 2 where the base piece contains an opening that aligns with the tubular passageway of the Nozzle.

4. Cap device that threads or otherwise attaches to a container.
